(19) United States
(12) Patent Application Publication
(10) Pub. No.: US 2008/0062684 A1
(43) Pub. Date: Mar. 13, 2008

(54) THEATRE LIGHT APPARATUS INCORPORATING INDEPENDENTLY CONTROLLED COLOR FLAGS

(76) Inventors: Richard S. Belliveau, Austin, TX (US); David K. Peck, Austin, TX (US); Joe Shelton Williamson, Austin, TX (US); Robert T. Smith, Austin, TX (US); David R. Dahly, Austin, TX (US); Michael Bell, Austin, TX (US); Keith D. Bickers, Round Rock, TX (US)

Correspondence Address: Walter J. Tencza Jr., Suite 3, 10 Station Place, Metuchen, NJ, 08840, US

(21) Appl. No.: 11/780,739

(22) Filed: Jul. 20, 2007

Related U.S. Application Data
(63) Continuation-in-part of application No. 11/516,822, filed on Sep. 7, 2006.

(51) Int. Cl. F21V 7/00; F21V 9/00

(52) U.S. Cl. 362/231; 362/285; 362/296

(57) ABSTRACT

A multiparameter light is disclosed, which incorporates an LED (light emitting diode) tracking ring surrounding a main output lens. The LED tracking ring is capable of additive color mixing and in turn can simulate the color of the main projected light projecting from the main output aperture or output lens of the multiparameter light.

### CROSS REFERENCE TO RELATED APPLICATION(s)

The present application is a continuation in part of and claims the priority of U.S. patent application Ser. No. 11/516,822, titled “THEATRE LIGHT APPARATUS INCORPORATING LED TRACKING SYSTEM”, filed on Sep. 7, 2006.

### FIELD OF THE INVENTION

This invention relates to multiparameter lighting fixtures.

### BACKGROUND OF THE INVENTION

Multiparameter lighting fixtures are lighting fixtures, which illustratively have two or more individually remotely adjustable parameters such as focus, color, image, position, or other light characteristics. Multiparameter lighting fixtures are widely used in the lighting industry because they facilitate significant reductions in overall lighting system size and permit dynamic changes to the final lighting effect. Applications and events in which multiparameter lighting fixtures are used to great advantage include showrooms, television lighting, stage lighting, architectural lighting, live concerts, and theme parks. Illustrative multi-parameter lighting fixtures are described in the product brochure showing the High End Systems product line for the year 2000 and are available from High End Systems, Inc. of Austin, Tex.

Multiparameter lighting fixtures are commonly constructed with a lamp housing that may pan and tilt in relation to a base housing so that light projected from the lamp housing can be remotely positioned to project on the stage surface. Commonly a plurality of multiparameter lights are controlled by an operator from a central controller. The central controller is connected to communicate with the plurality of multiparameter lights via a communication system. U.S. Pat. No. 4,392,187 titled “Computer controlled lighting system having automatically variable position, color, intensity and beam divergence” to Bornhorst and incorporated herein by reference, disclosed a plurality of multiparameter lights and a central controller.

The lamp housing of the multiparameter light contains the optical components and the lamp. The lamp housing is rotatably mounted to a yoke that provides for a tilting action of the lamp housing in relation to the yoke. The lamp housing is tilted in relation to the yoke by a motor actuator system that provides remote control of the tilting action by the central controller. The yoke is rotatably connected to the base housing that provides for a panning action of the yoke in relation to the base housing. The yoke is panned in relation to the base housing by a motor actuator system that provides remote control of the panning action by the central controller.

It is desirable for a multiparameter light to have a large light output aperture to create a large beam of light cross section. This often causes a problem because the final output lens that often establishes the output aperture of a multiparameter light must be large in diameter. When the output lens diameter exceeds eight inches the glass lens can become quite heavy. The increased weight of the lens requires a more expensive support frame and larger motors to drive the increased weight of the lamp housing.

### SUMMARY OF THE INVENTION

A novel high power multiparameter light apparatus is disclosed. The multiparameter light of one or more embodiments of the present invention incorporates an LED (light emitting diode) tracking ring surrounding a main output lens. The LED tracking ring is capable of additive color mixing and in turn can simulate the color of the main projected light projecting from the main output aperture or output lens of the multiparameter light. A multiparameter light of one or more embodiments of the present invention may incorporate a color mixing system using pairs of Cyan, Magenta and Yellow color mixing flags. Any individual color mixing flag may be independently varied to create a bicolor or a tricolor output light. A multiparameter light of one or more embodiments of the present invention may incorporate an optical power varying system that can convert the projected light from a multiparameter light from a hard edge to a soft edge.

### BRIEF DESCRIPTION OF THE DRAWINGS

FIG. 1 shows a multiparameter light in accordance with an embodiment of the present invention;

FIG. 2A shows a fresnel lens and an LED tracking ring incorporated into the multiparameter light of FIG. 1;

FIG. 2B shows an LED from the color tracking ring of FIG. 2A comprised of a plurality of separate colored LEDs;

FIG. 2C shows an LED from the color tracking ring of FIG. 2A comprised of a single RGB (red, green, and blue) LED;

FIG. 3 shows an internal view of components of a lamp housing of the multiparameter light of FIG. 1;

FIG. 4 shows an internal view of the components of the base housing of the multiparameter light of FIG. 1;

FIG. 5 shows a lighting system comprised or a plurality of multiparameter lights in accordance with an embodiment of the present invention connected for communication to a central controller;

FIG. 6 shows a color mixing system of the prior art;

FIG. 7 shows a color mixing system of an embodiment of the present invention; and

FIG. 8 shows a lighting system comprised or a plurality of multiparameter lights in accordance with another embodiment of the present invention connected for communication to a central controller.

### DETAILED DESCRIPTION OF THE DRAWINGS

In the description that follows, like parts are marked throughout the specification and drawings with the same reference numerals, respectively. The drawing figures are not necessarily to scale. Certain features of embodiments of the present invention may be shown exaggerated in scale or in somewhat schematic form and some details of conventional elements may not be shown in the interest of clarity and conciseness. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce the desired results.

In particular, various embodiments of the present invention provide a number of different methods and apparatus for operating and controlling multiple IPLD lighting systems. The concepts of the invention are discussed in the context of IPLD lighting systems but the use of the concepts of the present invention is not limited to IPLD systems and may find application in other lighting and other visual systems where control of the system is maintained from a remote location and to which the concepts of the current invention may be applied.

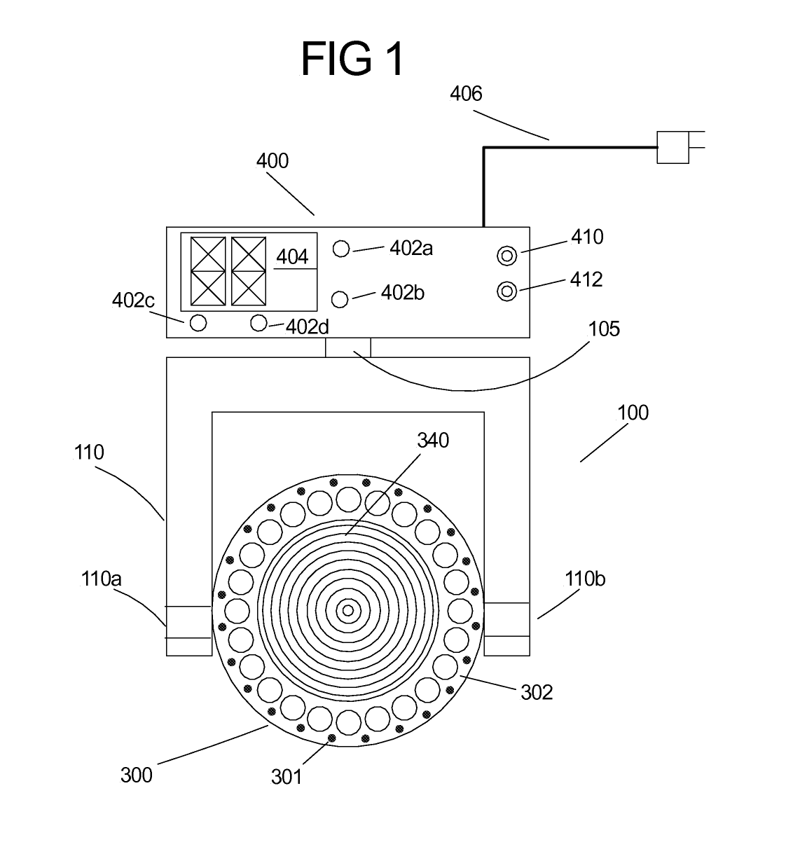

FIG. 1 shows a multiparameter light 100 in accordance with an embodiment of the present invention. The multiparameter light 100 includes a lamp housing 300 and a base housing 400. The multiparameter light 100 is capable of remotely panning and tilting the lamp housing 300 in relation to the base housing 400. The lamp housing 300 is mounted by bearing assemblies 110a and 110b so that the lamp housing 300 can tilt in relation to a yoke 110. The yoke 110 can pan in relation to the base housing 400 by means of a bearing 105. The lamp housing 300 is remotely tilted in relation to the base housing 400 by a first motor actuator not shown for simplicity. The yoke 110 is remotely panned in relation to the base housing 400 by a second motor actuator not shown for simplicity.

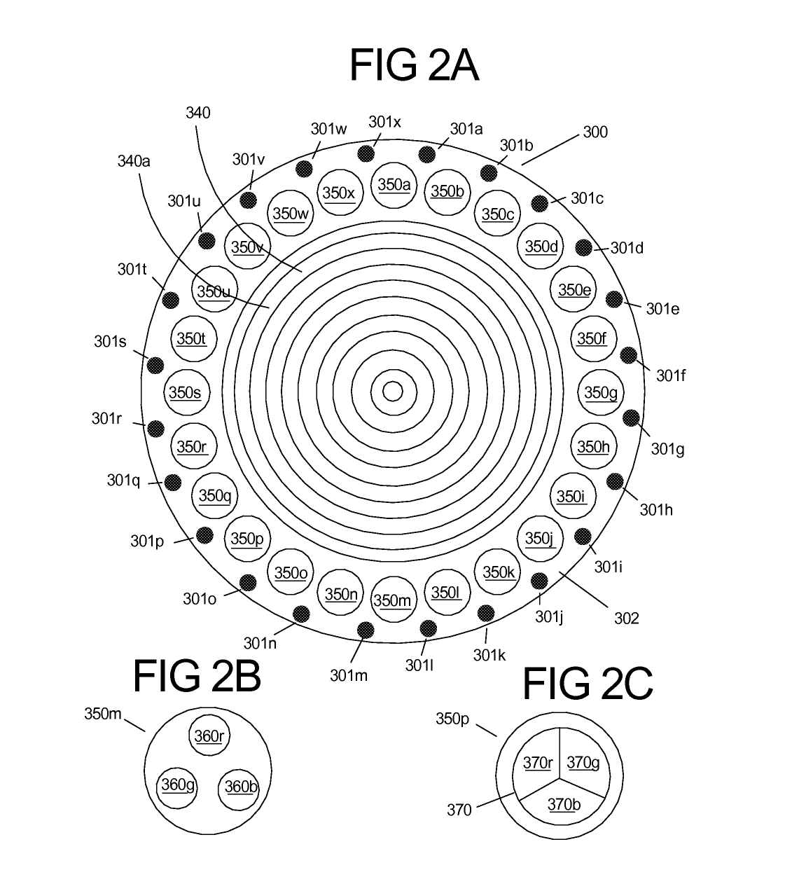

The lamp housing 300 includes, or has located therein, an output lens 340. The output lens 340 may be a polymer fresnel lens and typically is the main output lens of the lamp housing 300. A polymer fresnel lens is used in accordance with an embodiment of the present invention for output lens 340 to reduce the weight associated with glass fresnel lenses of the prior art. The output lens 340 includes an output aperture 340a shown in FIG. 2A. Also shown is a plurality of LEDs that are used for form an LED tracking ring 302. An air inlet vent 301 is position in proximity to the tracking ring 302. Glass fresnel lenses are used in the prior art for non-imaging applications and therefore are used in wash lights that do not project a pattern (referred to as gobo in the art). In accordance with one or more embodiments of the present invention, it has been found that with the use of a close tolerance polymer fresnel lens for output lens 340, patterns formed by gobos placed into a light path by a gobo wheel can be projected by an automated theatre light of one or more embodiments of the present invention without too much distortion caused by any abnormalities of the output lens 340. Generally, the use of a gobo wheel comprising gobo patterns that can be indexed into a light path for projection by an automated theatrical light is known in the art and is disclosed in U. S. Pat. No. 5,402,326 titled “Gobo Holder for a Lighting System”, inventor Richard Belliveau (co-inventor on present application The base housing 400 has a graphical display 404 and input keys 402a, 402b, 402c and 402d used for setting a communications address as well as controlling other functions of the multiparameter light 100. The multiparameter light also includes a power input cord 406 for connecting the multiparameter light 100 to a source of power.

FIG. 2A shows a more detailed drawing of a possible embodiment for the lamp housing 300. The LED tracking ring 302 is shown constructed of a circular array of LEDs shown as LEDs 350a through 350x that are located along the perimeter of the output lens 340 in a ring like fashion. In proximity to each LED 350a though 350x there is located an air intake vent 301a through 301x. The air intake vents 350a through 350x act to pull cooling air into the multiparameter light 100 and provide cooling for the LEDs 350a through 350x as well as providing cooling for the polymer fresnel lens 340.

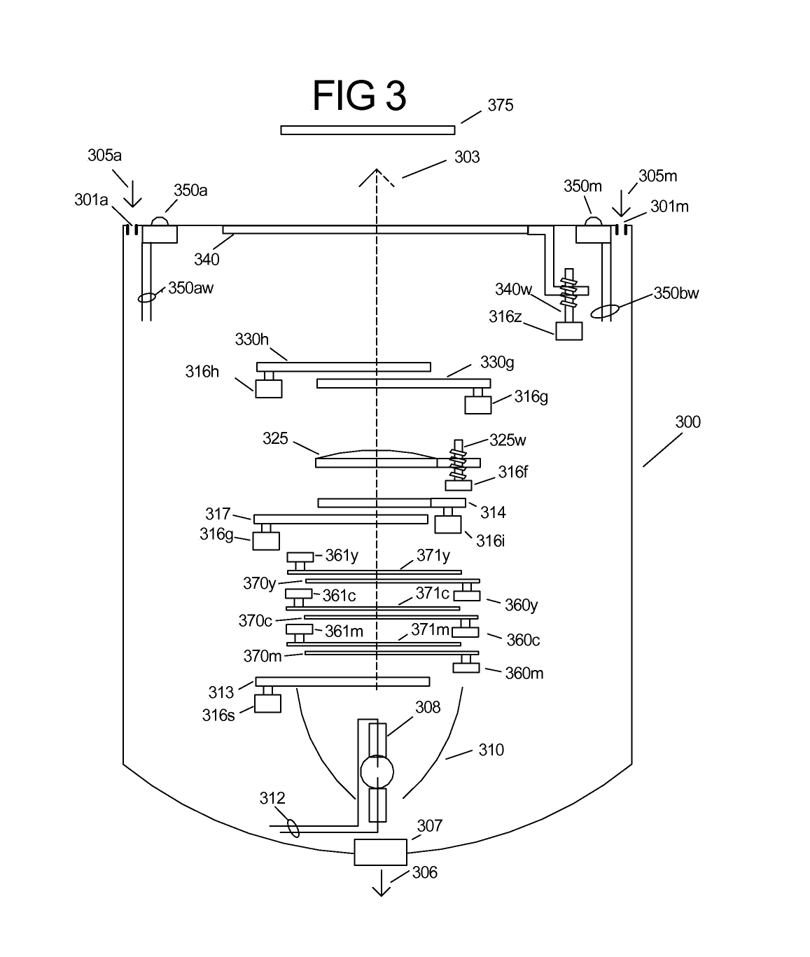

FIG. 3 shows an internal look at components of the lamp housing 300 of the multiparameter light 100 in accordance with an embodiment of the present invention. The lamp housing 300 includes, or has located therein, a central lamp 308. The central lamp 308 may be a metal halide, mercury, xenon, halogen, LED or other light source. The central lamp 308 has power wires 312 connected thereto.. The central lamp 308 is contained within a reflector 310 that reflects light emitted by the central lamp 308 forward along a light pathway 303 shown by a dashed line. The light path 303 is directed to project on to a projection surface 375. The projection surface 375 may be a screen, a stage floor or other surface. The lamp housing 300 includes, or has located therein, a strobe shutter 313, which is driven by a motor actuator 316s. The lamp housing 300 may further include, or have located therein, a subtractive color system using Cyan, Magenta and Yellow (referred to as CMY). The subtractive color system may be used to variably modify the colors of the projected light from the central lamp 308. The subtractive color system may be constructed of dichroic color filter media that is fashioned into color filter flags 370m, 371m, 370c, 371c, 370y, and 371y. A first magenta color mixing flag 370m can be driven in or out of the light path 303 by motor 360m. A second magenta color mixing flag 371m can be driven in or out of the light path 303 by a motor 361m. A first cyan color mixing flag 370c can be driven in or out of the light path 303 by a motor 360c. A second cyan color mixing flag 371c can be driven in or out of the light path 303 by a motor 361c. A first yellow color mixing flag 370y can be driven in or out of the light path 303 by motor 360y. A second yellow color mixing flag 371y can be driven in or out of the light path 303 by motor 361y. The system of CMY (cyan, magenta, and yellow) color filters acts as a color varying system to vary the color of the light emitted by the output lens 340. The CMY color mixing system for the multiparameter light 100 of FIG. 1 may use the color mixing flags disclosed in U.S. patent application titled “Improved Heat Resistant Color Mixing Flag for a Multiparameter Light” Ser. No. 11/765,539, inventor(s) Richard S. Belliveau et. al., filed on Jun. 20, 2007 incorporated herein by reference.

A gobo wheel 317 is shown and various gobos placed upon the gobo wheel can be driven into the light path or light pathway 303 by motor actuator 316g to be focused by a focusing lens 325 driven by a motor actuator 316f. The lamp housing 300 further includes, or has located therein, a variable iris 314. The variable iris 314 is remotely varied in the light path 303 by a motor actuator 316i. The focus lens 325 of FIG. 3 is shown varied in the light path 303 by a lead screw system 325w by motor actuator 316f. A first flag 330g is used to vary optical power and is varied in the light path 303 by a motor actuator 316g. A second flag 330h is used to vary optical power and is varied in the light path 303 by a motor actuator 316h. The first and second flags 330g and 330h, respectively, can be constructed of arrays of lenticular lenses, radial lenses or even clear art glass patterned with raised areas that can provide a power of magnification. A patterned glass used for the first flag 330g and the second flag 330h acts to randomize the light passing through the output lens 340, which may be a fresnel lens. The optical power varying flags 330g and 330h are used to convert the projected output of the output lens 340 from a hard edge (imaging application) to a soft edge (non-imaging application). When the optical power varying flags 330g and 330h are inserted fully into the light path 303, gobo images from the gobo wheel 317 are not focusable on the projection surface 375 and the automated theatre light or multiparameter light 100 converts from a hard edge to a soft edge light output from output lens 340. When the optical power varying flags 330g and 330h are removed from the light 303 path the multiparameter light 100 of FIG. 1 operates as a hard edge light that is capable of projecting the gobo images onto the projection surface 375.

The output lens 340 may typically be a fresnel lens constructed of a polymer. The polymer material may be clear acrylic or polycarbonate. The output lens 340 is varied in the optical path or light pathway 303 by lead screw system 340w driven by motor actuator 316z. The output lens 340 may work in conjunction with the focus lens 325 to operate as a zoom and focus lens system.

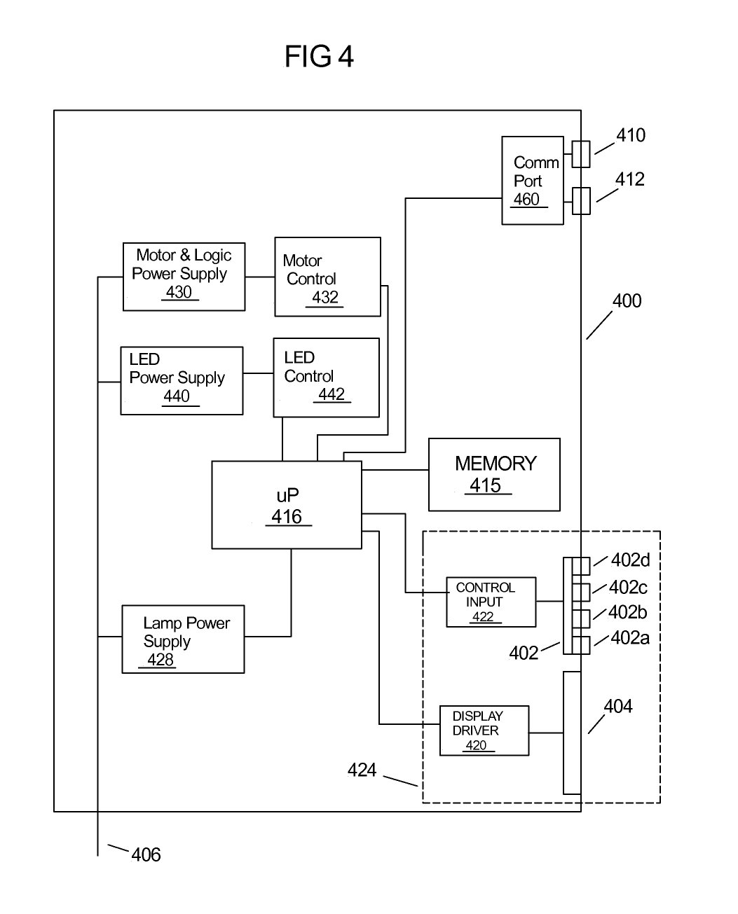

An LED (light emitting diode) 350a is shown along with the simplified wiring connection points 350aw. A second LED (light emitting diode) 350m is shown along with simplified connection points 350bw. The connection points 350aw and 350bw connect to the LED control 442 of FIG. 4 but are not shown connected for simplification. The LEDs 350a and 350m of FIG. 3 are the same as LEDs 350a and 350m of FIG. 2A. In the drawing of the lamp housing 300 of FIG. 3 only two of the LEDs that make up the LED tracking ring 302 of FIG. 2A are shown for simplicity.

Air cooling vents 301a and 301m are shown in proximity to LED 350a and LED 350m respectively, as shown in FIG. 3 Air intake is shown in the direction of arrow 305a for vent 301a and arrow 305m for vent 301m, as shown in FIG. 3. The air intake from vents 301a and 301m keep the LEDs 350a and 350m cool as well as providing cooling for the output lens 340 (which is typically a polymer fresnel lens). A cooling fan 307 pulls outside air into the vents 301a and 301m and exits the air in the direction of arrow 306. It is important that the heat from the lamp 308 not stagnate in the area of the LEDs 350a through 350x, shown in FIG. 2A, or the output or polymer fresnel lens 340 when the lamp housing 300 is in the up position, and the heat from the lamp 308 rises. Input cooling air from the cooling vents 301a through 301x shown in FIG. 2A keeps the hot air generated by the heat from the lamp 308 from stagnating around the LEDS 350a-x and the output or polymer fresnel lens 340. It is preferred that the cooing vents 301a through 301x be therefore in proximity a corresponding LED of the LEDs 350a-x and/or the output or polymer fresnel lens 340.

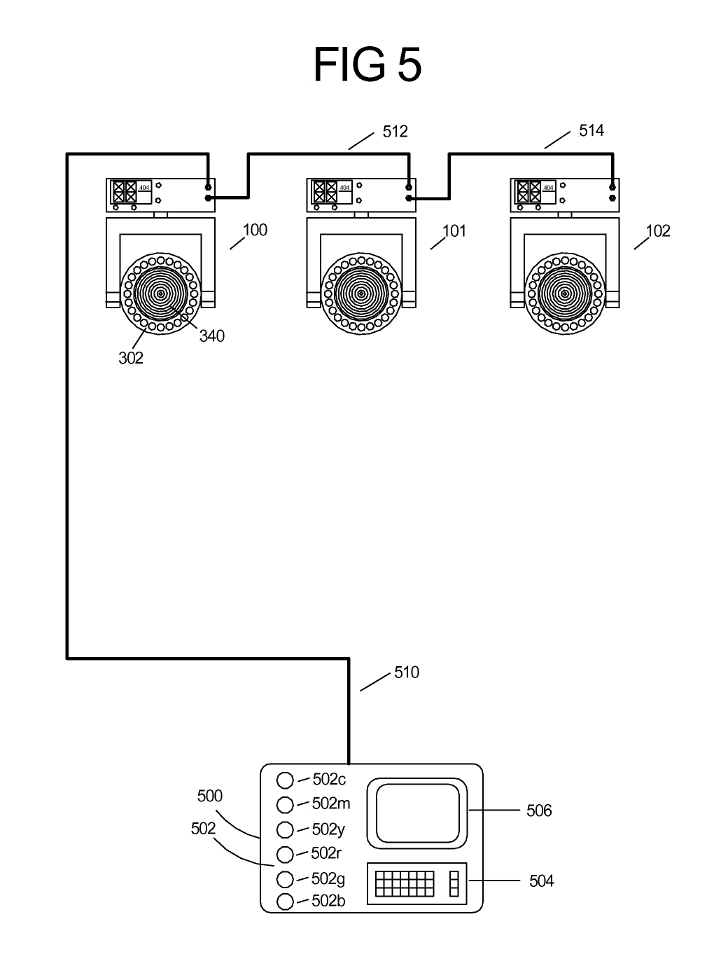

FIG. 4 shows components in the base housing 400 of FIG. 1. A power input cord 406 is shown for providing a means of supplying operating power. Two communication input connectors 410 and 412 are shown connected to a communications port 460. The communications port 460 may be constructed of an industry standard RS422 or RS485 driver system as known in the art. The communications port 460 forwards control information to a processor 416. The processor 416 may be a single processor or a plurality of processors working together. The processor 416 working in conjunction with operational code stored in a memory 415 receives commands from a central control system such as a central controller 510 shown in FIG. 5. The processor 416 may send instructions to a motor actuator control 432 to vary the state of motors 316s, 360m, 370m, 360c, 370c, 360y, 370y, 316g, 316i, 316f, 316g, 316h, and 316z, previously described with reference to FIG. 3 (wiring connections not shown for simplification). The motors previously described with reference to FIG. 3, are preferably stepping type motor actuators but many other types of actuators known in the art could be used.

The motor control 432 also can vary the pan and tilt motors, not shown for simplification, that cause the lamp housing 300 to tilt in relation to the yoke 110 and the yoke 110 to pan in relation to the base housing 400. The base housing 400 also includes or may have located therein, a motor and logic power supply 430, which may supply the necessary power to operate all of the motors and the logic circuitry included or inside the base housing 400.

The processor 416 may operate to send control signals to a lamp power supply 428 which remotely enable and power the central lamp 308. The processor 416 may send control signals to an LED control 442 that is connected (wiring not shown for simplification) to the plurality of LEDs 350a through 350x that comprise the LED tracking ring 302 of FIG. 1. The LED control 442 provides three separate control signals that include a first control signal for the simultaneous control of all of the red LEDs, a second control signal for the simultaneous control of all of the green LEDs and a third control signal for simultaneous control of all of the blue LEDs that make up the LEDs 350a through 350x. Alternatively the LED control 442 may provide a separate control signal for each red, blue and green component of each of the LEDs 350a through 350x. The LED power supply 440 may supply the necessary power to operate the LEDs 350a through 350x that are provided their driving signals by the LED control 442. The LEDs 350a though 350x emit variably colored light that can color match the color of the light projected by the output lens 340 through the output aperture 340a shown in FIG. 2A.

External input buttons switches 402a, 402b, 402c, and 402d may be mounted to a circuit board 402 which may be or may be part of a means for external input commands. The action of switches 402a, 402b, 402c, and 402d are read by a control input 422 and sent to the processor 416 as external input commands. A display device 404, which may be a dot matrix or other graphical display, is used to provide feedback to an operator. The display device 404 is driven by a display driver 420 that receives commands from the processor 416 to alter display characters of the display device 404. The switches 402a, 402b, 402c and 402d, circuit board 402, control input 422, display device 404 and the display driver 420 are components of a stand alone control system 424 shown by the dashed lines.

FIG. 5 shows three multiparameter lights or multiparameter theatre lights 100, 101 and 102 in accordance with an embodiment of the present invention connected by communications wires 510, 512 and 514 to a central controller 500. The central controller 500 can communicate commands to the multiparameter theatre lights 100, 101 and 102 using the DMX protocol standard developed by the United States Institute for Theatre Technology of Syracuse, N.Y., which is commonly used for communication between theatrical devices. The central controller 500 has a display device 506, input devices 502 and a keyboard 504. The input devices 502 include input devices 502c, 502m, 502y, 502r, 502g, and 502b. The input devices 502 and the keyboard 504 may be any type of input devices including potentiometers, encoders or a touch screen that is placed over the display device 506 An operator of the central controller may remotely operate the lights 100, 101 and 102 by inputting to the input devices 502c, 502m, 502y, 502r, 502g, 502b and the keyboard 504. The display device 506 may also be a touch screen display device and as such may also accept input commands from an operator. The central controller 500 may be equipped to vary the color and intensity of the LED tracking ring 302 of FIG. 2A as well as the color and intensity of the light projected from the output lens 340. The light projected by the output lens 340 and through output aperture 340a can also be referred to as the main output light. It is preferred that the output lens 340 be both the output lens and have an output aperture 340a, but is it also possible for the output aperture to be separate from the lens such as when using a clear window placed after the lens. Although only three automated theatre lights 100, 101 and 102 of an embodiment of the present invention are shown in FIG. 5, many more theatre lights in accordance with one or more embodiments of the invention may be controlled by the central controller 500.

The LEDs in the color tracking ring 350a through 350x of FIG. 2A may each be comprised of a plurality of Red, Green and Blue separate LEDs. FIG. 2B shows LED 350m of FIG. 2A comprised of separate LEDs 360r, 360g, and 360b. Separate LED 360r represents a separate red LED, separate LED 360g represents a separate green LED, and separate LED 360b represents a separate blue LED. FIG. 2C shows LED 350p of FIG. 2A comprised of a single LED that has been manufactured to incorporate three LED dies 370r, 370g, and 370b into a single output aperture 370. It is preferred that the LED tracking ring 302 be comprised of LEDs 350a through 350x, each of which have been manufactured to incorporate the red, green and blue LED dies into a single output aperture like the RGB LED shown in FIG. 2C. The single package red, green and blue (RGB) provides a better homogenous color blend to the eye when looking at the system operate.

The multiparameter theatre light 100 can operate to project light (main output light) originating from the central lamp 308 and passing through the output lens 340 and output lens aperture 340a. The motors 316c, 316m and 316y can be used to vary the color filter flags 320c, 320m and 320y into the light pathway 303. Varying the color filter flags 320c, 320m and 320y varies the saturation of the cyan, magenta and yellow color, respectively, applied to light in the light pathway 303. Varying the color of the projected light from a multiparameter theatre light, by using cyan, magenta and yellow filters is well known in the art. This practice is referred to as CMY (cyan, magenta and yellow) color mixing. CMY is also referred to in the art as “subtractive color mixing”. A product called “Cyberlight” (trademarked) manufactured by High End Systems and described in the “The High End Systems Product Line 2001” brochure makes use of a CMY system to vary the color of the projected light.

The multiparameter theatre light 100 of FIG. 5 is typically remotely controlled by an operator of the central controller 500. The operator first selects which of the plurality of multiparameter theatre lights 100, 101 and 102 the operator wishes to control by inputting an address into the keyboard 504. If the operator enters the address of light 100 the operator may next vary the CMY saturation of the main output remotely by adjusting input devices 502c for cyan, 502m for magenta, and 502y for yellow. The color varying control commands created by the operator with the control system 500 are sent over the communication wire 510 and received by the communications port 460 of FIG. 4. The communications port 460 passes the commands to the processor 416. The processor 416 acts on the color varying commands in accordance with the operating software stored in the memory 415 and sends the appropriate control signals to the motor control system 432. The motor control system 432 sends driving signals to the motors 316c, 316m and 316y to vary the CMY color flags 320c, 320m, and 320y, respectively, into the light path 303 to the desired color variation specified by the operator of the control system 500.

The operator may individually adjust cyan, magenta or yellow to achieve a mixed color in the visible spectrum.

The multiparameter theatre light 100 of FIG. 5 may also have the LED tracking ring color (i.e. produced by LEDs 350a-x) varied by an operator of the central controller 500 in a similar manner to the CMY control used for varying the color of the main output (i.e. produced from lamp 308 through aperture 340a of lens 340). After selecting the multiparameter theatre light 100, for example, the operator can adjust the input devices 502r, 502g and 502b. In response to the adjustment of the input devices 502r, 502g and 502b, the tracking ring color varying commands are created by the central controller 500 and are sent over communications wire 510 to the light 100. The light 100 receives the tracking ring color varying commands at the communications port 460 and sends the received commands to the processor 416. The processor 416 acts on these commands in accordance with the operating software stored in the memory 415 and sends the appropriate control signals to the LED control 442. The LED control 442 sends driving signals to the LEDs 350a though 350x to control the LEDs intensity to vary the color emitted by the LEDs to that specified by the operator of the central controller 500.

When the operator adjusts the input device 502r of FIG. 5 the intensity of the red part, section, or separate LED of all of the LEDs 350a though 350x of FIG. 2A are simultaneously adjusted. When the operator adjusts the input device 502b of FIG. 5 the intensity of the blue part, section or separate LED of all of the LEDs 350a though 350x of FIG. 2A are simultaneously adjusted. When the operator adjusts the input device 502g of FIG. 5 the intensity of the green part, section or separate LED of all of the LEDs 350a though 350x of FIG. 2A are simultaneously adjusted. This allows the operator to control the intensity of the red, green and blue LEDs that make up the LEDS 350a though 350x of FIG. 2A. Controlling the intensity of the red, green and blue LEDs that comprise LEDs 350s through 350x provides for an additive color mixing or RGB mixing of the color tracking ring 302. The term additive color mixing (or RGB color mixing) is well defined in the art. An additive color mixing system combines the primary colors of red , green and blue sources of light (RGB) to produce the secondary colors of cyan, magenta, and yellow (CMY). Combining all three primary colors in equally perceived intensities can produce white. Varying the intensities of the red, green and blue results in producing a wide variation of color. The RGB color mixing allows the color tracking ring 302 to vary color within the visible spectrum in a different way than CMY color mixing that is accomplished by varying the color mixing flags 320c, 320m and 320y into the light path 303 of the projected light that is created by the central lamp 308 and the projected light created by the lamp 308 and projected by through the lens aperture 340a is referred to as the main output. The operator can use the LED tracking ring 302 to match a visible color of the main output project light. This produces a pleasing effect where the color of the main output projected light is color matched or tracked by the light created by the LED tracking ring 302.

In practice the multiparameter theatre lights 100, 101 and 102 of FIG. 5 may each have a blue light projected as a main output projected light from the lens aperture 340a of FIG. 3 using CMY color mixing and the color tracking ring 302 may be color matched to the blue color of the main output projected light. Alternatively a pleasing complementary color may be created by the color tracking ring 302 in relation to the color of the main output projected light. If the colored light projected by the main output is blue then the color tracking ring 302 may be adjusted by an operator of the central control system 500 using the input controls 502r, 502b and 502y to produce a yellow light by varying the RGB LEDs 350a though 350x. The color of the main output projected light can be matched to the color tracking ring 302 by an operator of the central control system 500 of FIG. 5. Alternatively a complementary color can be created.

The multiparameter theatre light 100 of FIG. 1 can also create a strobing effect of the main output projected light projected through the lens 340 and the aperture 340a of FIG. 1. This is accomplished when an operator of the control system 500 of FIG. 5 selects one of the multiparameter theatre lights 100, 101 or 102 by inputting the correct address of the desired light the operator wishes to remotely control. If the operator has selected light 100 then the operator may adjust a strobe rate by inputting to the keypad 504. The rate can be a variable strobe rate but most strobe rates are variable between one Hz to twenty Hz. Upon receiving the main output strobe commands generated by the central controller 500 and sent over the communication wire 510 the light 100 receives the strobe commands at the communications port 460 and sends the received commands to the processor 416. The processor 416 acts on the main output strobe commands in accordance with the operating software stored in the memory 415 and sends the appropriate control signals to the motor control system 432. The motor control system 432 sends driving signals to the motor 316s to drive the strobe shutter 313 into and out of the light path 303 at the desired control rate specified by the operator of the control system 500. The use of a strobe shutter in a light path of a multiparameter light, in a general sense, is known in the theatre art.

The operator of the control system 500 of FIG. 5 may also wish to control the LED tracking ring 302 to strobe the intensity of the light emitted by the LEDs 350a thought 350x. The operator of the control system 500 after selecting one or more of the plurality of multiparameter theatre lights 100, 101 and 102 of FIG. 5 may enter an input with the input keyboard 504 to enter a strobe rate for the LED tracking ring 302. In this example the operator has selected the light 100 and wishes to control the strobe rate of the LED tracking ring 302 to create a new dynamic effect. The central controller 500 of FIG. 5 sends the LED tracking ring strobe commands to the multiparameter theatre light 100 over communications wire 510. Upon receiving the LED tracking ring strobe commands generated by the central controller 500 the light 100 receives the LED tracking strobe commands at the communications port 460 and sends the received commands to the processor 416. The processor 416 acts on these commands in accordance with the operating software stored in the memory 415 and sends the appropriate control signals to the LED control 442. The LED control 442 sends driving signals to the LEDs 350a though 350x to control the LEDs intensity at a rate used to create the required strobe rate. The strobe rate of the LED tracking ring 302 may be synchronous and in phase with the strobe rate of the main output projected light projected through the output lens 340 and through the aperture 340a or the strobe rate be different. Alternatively, the operator of the central control system 500 of FIG. 5 may cause the strobe rate of the main output projected light to toggle with the strobe of the LED tracking ring 302. Toggle is explained as the following: When light is being projected from the main output, i.e. from output lens 340, the LED tracking ring 302 is essentially in a dark phase of the strobe cycle. During the dark portion of the strobe cycle of the main output projected light, the strobe portion of the LED tracking ring 302 is in the illumination phase. In this way a strobe toggle is created by toggling light output between the main output projected light from lens 340 and the light from the LED tracking ring 302 in synchronization.

The commands for the color varying of the main output and the LED tracking ring 302 and the strobe commands for the main output and LED tracking ring 302 can also be created by an operator inputting to the stand alone control system 424. The operator may input commands through the input devices 402a, 402b, 402c and 402d. The input commands received by the use of input devices 402a, 402b, 402c and 402d can be sent from the control input system 422 to the processor 416. The processor 416 acting in accordance with the memory 415 can process the commands to control the color varying or strobing of the main output projected light from output lens 340 or the LED tracking ring 302.

The LED tracking ring 302 is shown surrounding the aperture 340a of the output lens 340 and it is preferred to be a ring that surrounds the aperture 340a. The LED tracking ring 302 could take on a different look if desired and may be constructed of a different geometric shape other than a ring. The lamp 308 could also be a comprised of a plurality of LEDs and in this case the lens 340 would not be required. Alternatively, the output lens 340 and aperture 340a may not be located in the center of the LED tracking ring 302.

The red LEDs of the LED tracking ring 302 may be connectively wired so that all red LED components of the LEDs 350a through 350x of the tracking ring 302 are driven simultaneously as described. The blue LEDs of the LED tracking ring 302 may be wired so that all blue LED components of the LEDs 350a through 350x of the tracking ring 302 are driven simultaneously as described. The LEDs of the LED tracking ring 302 may be wired so that all green LED components of the LEDs 350a through 350x of the tracking ring 302 are driven simultaneously as described. Alternatively separate control of each color component of each LED 350a through 350x may be driven by the LED control 442 of FIG. 4.

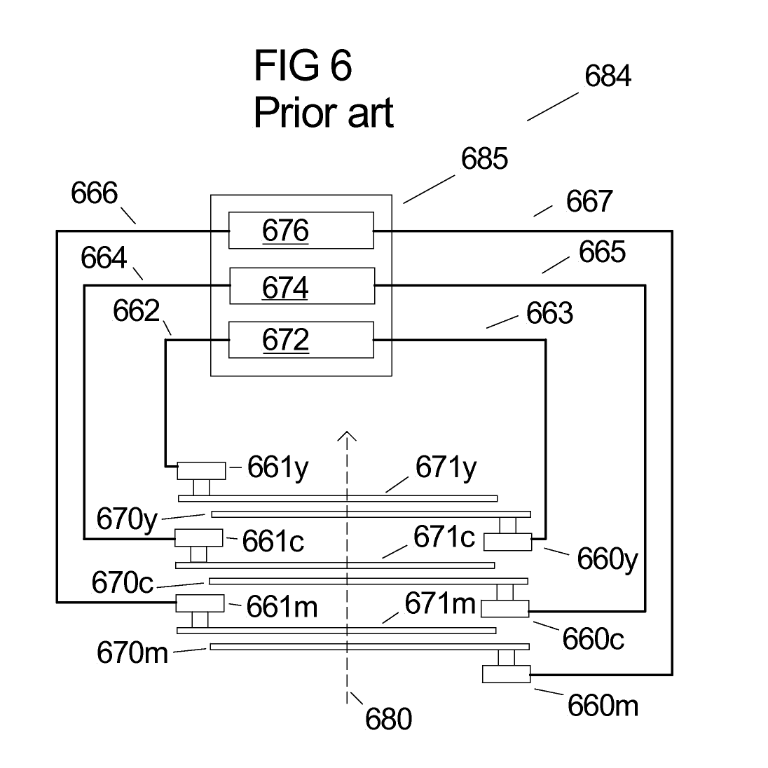

FIG. 6 shows a color mixing system of the prior art 684. A motor control circuit 685 is shown supplying three separate motor control signal outputs 676, 674 and 672. Motor control signal output 676 is connected to signal wires 666 and 667 to operate motors 661m and 660m that in turn position the magenta color mixing flags 671m and 670m, respectively. Motor control signal output 674 is connected to signal wires 664 and 665 to operate motors 661c and 660c that in turn position the cyan color mixing flags 671c and 670c, respectively. Motor control signal 672 is connected to signal wires 662 and 663 to operate motors 661y and 660y that in turn position the yellow color mixing flags 671y and 670y, respectively. With the prior art color mixing system 684 of FIG. 6 each two motors that control their perspective color mixing flags receive the same motor control signal output. In this manner each pair of two cyan, magenta or yellow color mixing flags are positioned in or out of light path 780 simultaneously as known in the prior art.

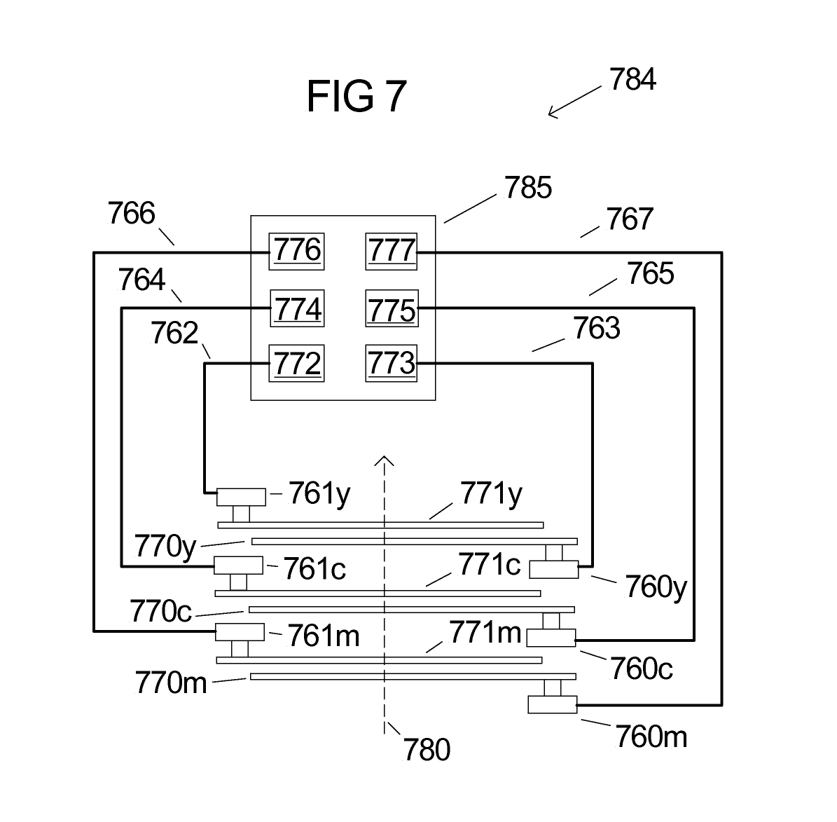

It has been found during experimentation with the multiparameter light 100 of FIG. 1 that allowing each of the six color mixing flags to individually move in or out of the light path results in an innovative and desirable pleasing bicolor or even a tricolor output light . FIG. 7 shows a color mixing system 784 of the present invention. A motor control circuit 785 is shown supplying six separate motor control signals 776, 777, 774, 775, 772 and 773. Motor control signal output 776 is connected to signal wire 766 to operate motor 761m that in turn positions the first magenta color mixing flag 771m in or out of the light path shown as arrow 780. Motor control signal output 777 is connected to signal wire 767 to operate motor 760m that in turn positions the second magenta color mixing flag 770m in or out of the light path shown as arrow 780. Motor control signal output 774 is connected to signal wire 764 to operate motor 761c that in turn positions the first cyan color mixing flag 771c in or out of the light path shown as arrow 780. Motor control signal output 775 is connected to signal wire 765 to operate motor 760c that in turn positions the second cyan color mixing flag 770c in or out of the light path shown as arrow 780. Motor control signal output 772 is connected to signal wire 762 to operate motor 761y that in turn positions the first yellow color mixing flag 771y in or out of the light path shown as arrow 780. Motor control signal output 773 is connected to signal wires 763 to operate motor 760y that in turn positions the second yellow color mixing flag 770y in or out of the light path shown as arrow 780.

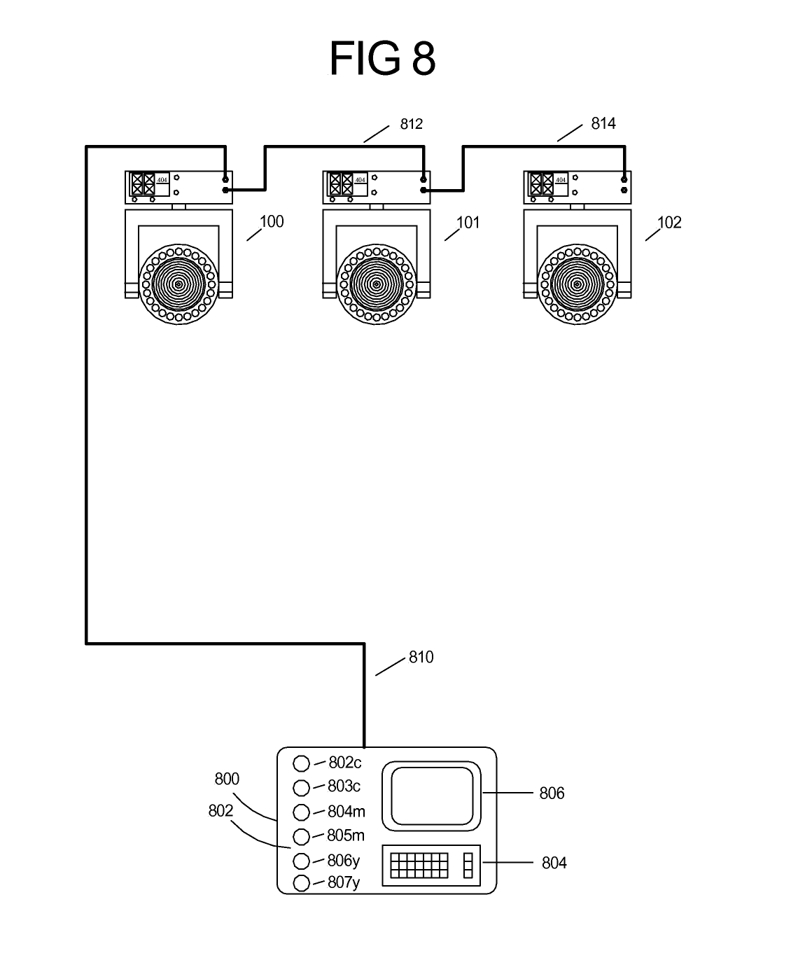

The motor control circuit 785 of FIG. 7 is similar to the motor control circuit 432 of FIG. 4 in that the motor control circuit 432 provides all six motors 360m, 361m, 360c, 361c, 360y and 361y of FIG. 3 with independent motor control signals and as such enable the motors to separately position each of their respective color mixing flags 370m, 371m, 370c, 371c, 370y, and 371y in or out of the light path 303. The six color mixing flags 370m, 371m, 370c, 371c, 370y, and 371y are comprised of pairs of like colors. The six color mixing flags are comprised of two magenta like color mixing flag pairs 370m and 371m, two cyan like color mixing flag pairs 370c and 371c and two yellow like color mixing flags 370y and 371y. In accordance with an embodiment of the present invention, the multiparameter light 100 of FIG. 1 may independently vary any of the six color mixing flags 370m, 371m, 370c, 371c, 370y, and 371y in or out of the light path or partially in or out of the light path, such as light path 303 of FIG. 3. The multiparameter lights 100, 101 and 102 of FIG. 8 receive control commands from the central controller 800 of FIG. 8. The control commands may be in the form of the DMX protocol.

An operator of the central controller 800 of FIG. 8 first selects which of the plurality of multiparameter lights 100, 101 and 102 (which may be multiparameter theatre lights)the operator wishes to control by inputting an address into the keyboard 804. If the operator enters the address of light 100, the operator may next independently vary any one of yellow, cyan and magenta color mixing flags in or out of the appropriate light path or any where in between. The operator of the control system 800 may use input devices 802 to individually control each of the six color mixing flags, such as 370m, 371m, 370c, 371c, 370y and 371y of FIG. 3 in or out of the light path 303 or any place in between. Input knobs 802c and 803c can independently vary the position of the color mixing flags 770c and 771c of FIG. 7 respectively. Input knobs 804m and 805m can independently vary the position of the color mixing flags 770m and 771m of FIG. 7 respectively. Input knobs 806y and 807y can independently vary the position of the color mixing flags 770y and 771y of FIG. 7 respectively. When any of the input knobs 802c, 803c, 804m, 805m, 806y and 807y are varied, commands signals are sent from the central controller 800 over communication wires 810, 812 and 814 and received by communications port 460 of FIG. 4. The communications port 460 of FIG. 4 passes the color varying commands to processor 416 where it acts on the commands in accordance with the operational software stored in the memory 415 to send color flag varying control signals to the motor control 432. The motor control 432 may then send motor control signals to independently vary any one of the color mixing flag motors 360m, 361m, 360c, 361c, 360y or 361y of FIG. 3.

We claim:

1. A theatre lighting apparatus comprising:
a base;
a communications port;
a processor;
a memory;
a lamp housing;
the lamp housing comprising;
a central lamp,
a reflector;
a color varying system;
a lens;
an output aperture;
wherein the lamp housing is remotely positioned in relation to the base by a motor;
wherein the central lamp, the reflector, the color varying system, and the lens cooperate to project a first variable colored light from the output aperture;
wherein the color varying system is comprised of a plurality of color flags, wherein the plurality of color flags is comprised of a plurality of color pairs;
wherein each color pair includes a first color mixing flag and a second color mixing flag both of which are the same color;
wherein each color pair has a different color from the other color pairs of the plurality of color flags;
wherein the plurality of color pairs includes a first color pair;
wherein the first color mixing flag of the first color pair is varied in response to a command received by the communications port without varying the second color mixing flag of the first color pair.

2. The theatre lighting apparatus of claim 1 wherein the command is compliant with the DMX protocol.

3. A theatre lighting apparatus comprising:
a base;
a communications port;
a processor;
a memory;
a lamp housing;
the lamp housing comprising;
a central lamp,
a reflector;
a color varying system;
wherein the lamp housing is remotely positioned in relation to the base by a motor;
wherein the lamp housing generates a light having a light path;
wherein the color varying system is comprised of a plurality of color flags;
wherein the plurality of color flags are configured so that no more than one of the plurality of color flags can be varied across the light path in response to a command received by the communications port.

4. The theatre lighting apparatus of claim 3 wherein the plurality of color flags are comprised of a plurality of color pairs;
wherein each color pair includes a first color mixing flag and a second color mixing flag both of which are the same color; and
wherein each color pair has a different color from the other color pairs of the plurality of color flags.

5. The theatre lighting apparatus of claim 3 wherein the command is compliant with the DMX protocol.

6. A theatre lighting system comprising;
a multiparameter light comprising;
a lamp;
a color mixing system;
a communications port;
wherein the multiparameter light generates a light having a light path;
wherein the color mixing system is comprised of a plurality of color mixing flags comprised of a plurality of color pairs;
wherein each color pair includes a first color mixing flag and a second color mixing flag both of which are the same color; and
wherein each color pair has a different color from the other color pairs of the plurality of color flags.
wherein each of the plurality of color mixing flags can be varied individually across the light path by an associated motor; and
further comprising a central controller; and
wherein the central controller is comprised of a plurality of input devices, including a first input device; and
wherein the first input device can be varied by an operator to vary no more than one of the plurality of color mixing flags across the light path..

7. A theatre lighting apparatus comprising:
a base;
a communications port;
a processor;
a memory;
a lamp housing;
the lamp housing comprising;
a central lamp,
a reflector;
a color varying system;
a gobo;
a polymer fresnel lens;
an optical power varying system;
wherein the central lamp generates a light having a light path;
wherein the lamp housing is remotely positioned in relation to the base by a motor;
wherein in a first state the optical power varying system is substantially placed out of the light path;
wherein in a second state the optical power varying system is substantially placed into the light path;
wherein in the first state a gobo image from the gobo is substantially projected onto a projection surface; and
wherein in the second state a gobo image from the gobo is not substantially projected onto the projection surface.

8. A theatre lighting apparatus comprising:
a base;
a communications port;
a processor;
a memory;
a lamp housing;
the lamp housing comprising;
a central lamp;
a reflector;
a color varying system;
a gobo;
a polymer fresnel lens;
an optical power varying system;
wherein the central lamp generates a light having a light path;
wherein the lamp housing is remotely positioned in relation to the base by a motor;
wherein in a first state the optical power varying system is substantially placed out of the light path;
wherein in a second state the optical power varying system is substantially placed into the light path;
wherein in the first state the theatre lighting apparatus projects a hard edge light onto a projection surface; and
wherein in the second state the theatre lighting apparatus projects a soft edge light onto the projection surface.

9. The theatre lighting apparatus of claim 7
wherein the optical power varying system is comprised of two flags of patterned glass.

10. The theatre lighting apparatus of claim 8
wherein the optical power varying system is comprised of two flags of patterned glass.

11. A theatre lighting apparatus comprising:
a base;
a communications port;
a processor;
a memory;
a lamp housing;
the lamp housing comprising;
a central lamp,
a reflector;
a color varying system;
a lens;
an output aperture;
wherein the central lamp generates a light having a light path;
wherein the lamp housing is remotely positioned in relation to the base by a motor;
wherein the central lamp, the reflector, the color varying system, and the lens cooperate to project a first variable colored light from the output aperture;
wherein the color varying system is comprised of a plurality of color flags, including a first magenta flag, a second magenta flag, a first cyan flag, and a second cyan flag;
wherein the first magenta flag is varied into the light path by a first motor;
wherein the second magenta flag is varied into the light path by a second motor;
wherein the first cyan flag is varied into the light path by a third motor;
wherein the second cyan flag is varied into the light path by a fourth motor;
wherein the first magenta flag is varied into the light path in response to a first command received by the communications port;
and wherein the second magenta flag is not varied into the light path in response to the first command.

12. The theatre lighting apparatus of claim 11 wherein
the communications port receives a second command and the first cyan flag is varied into the light path in response to the second command and the second cyan flag is not varied into the light path in response to the second command.

13. The theatre lighting apparatus of claim 12 wherein
the first and second commands are compliant with the DMX protocol

14. A theatre lighting apparatus comprising:
a base;
a communications port;
a processor;
a lamp housing;
the lamp housing comprising;
a central lamp,
a reflector;
a color varying system;
a gobo;
polymer lens; and
a plurality of air vents; and
wherein the lamp housing is remotely positioned in relation to the base by a motor;
wherein the central lamp, the reflector, the color varying system, and the polymer lens cooperate to project a first variable colored light; and
wherein the plurality of air vents is located in proximity to the polymer lens.

15. The theatre lighting apparatus of claim 14 wherein
the polymer lens is a fresnel lens.

16. The theatre lighting apparatus of claim 14 wherein
the air vents are intake air vents.

17. A theatre lighting apparatus comprising:
a base;
a communications port;
a processor;
a lamp housing;
the lamp housing comprising;
a central lamp,
a reflector;
a color varying system;
a lens;
polymer lens;
a plurality of air vents;
a plurality of light emitting diodes;
wherein the lamp housing is remotely positioned in relation to the base by a motor;
wherein the central lamp, the reflector, the color varying system, and the polymer lens cooperate to project a first variable colored light from the output aperture;
wherein the vent is located in proximity to the polymer lens and the plurality of light emitting diodes.

18. The theatre lighting apparatus of claim 17 wherein
the polymer lens is a fresnel lens.

19. The theatre lighting apparatus of claim 18 wherein
the air vents are intake air vents.

20. A method comprising:
remotely positioning a lamp housing of a theatre lighting apparatus in relation to a base of the theatre lighting apparatus by a motor;
causing a central lamp, a reflector, a color varying system, and a lens of the theatre lighting apparatus to cooperate to project a first variable colored light from an output aperture of the theatre lighting apparatus;
wherein the color varying system is comprised of a plurality of color flags, wherein the plurality of color flags is comprised of a plurality of color pairs;
wherein each color pair includes a first color mixing flag and a second color mixing flag both of which are the same color;
wherein each color pair has a different color from the other color pairs of the plurality of color flags;
wherein the plurality of color pairs includes a first color pair;
and further comprising varying the first color mixing flag of the first color pair in response to a command received by a communications port of the theatre lighting apparatus without varying the second color mixing flag of the first color pair.

21. The method of claim 20 wherein
the command is compliant with the DMX protocol.

22. A method comprising:
remotely positioning a lamp housing of a theatre lighting apparatus in relation to a base of the theatre lighting apparatus by a motor;
wherein the lamp housing generates a light having a light path;
wherein the theatre lighting apparatus is comprised of a color varying system;
wherein the color varying system is comprised of a plurality of color flags;
and further comprising configuring the plurality of color flags so that no more than one of the plurality of color flags can be varied across the light path in response to a command received by the communications port.

23. The method of claim 22 wherein
the plurality of color flags are comprised of a plurality of color pairs;
wherein each color pair includes a first color mixing flag and a second color mixing flag both of which are the same color; and
wherein each color pair has a different color from the other color pairs of the plurality of color flags.

24. The method of claim 22 wherein
the command is compliant with the DMX protocol.

25. A method comprising;
generating a light having a light path from a multiparameter light;
wherein the multiparameter light includes a color mixing system comprised of a plurality of color mixing flags comprised of a plurality of color pairs;
wherein each color pair includes a first color mixing flag and a second color mixing flag both of which are the same color; and
wherein each color pair has a different color from the other color pairs of the plurality of color flags.
further comprising varying each of the plurality of color mixing flags individually across the light path by an associated motor;
further comprising varying a first input device of a central controller by an operator to vary no more than one of the plurality of color mixing flags across the light path.

26. A method comprising:
generating a light having a light path from a central lamp from a theatre lighting apparatus;
remotely positioning a lamp housing in relation to a base by a motor;
in a first state, placing an optical power varying system substantially out of the light path;
in a second state, placing the optical power varying system substantially into the light path;
in the first state, projecting a gobo image from a gobo onto a projection surface; and
in the second state, substantially not projecting the gobo image from the gobo onto the projection surface.

27. A method comprising:
generating a light having a light path from a central lamp of a theatre lighting apparatus;
remotely positioning a lamp housing of the theatre lighting apparatus in relation to a base of the theatre lighting apparatus by a motor;
in a first state, placing an optical power varying system substantially out of the light path;
in a second state, placing the optical power varying system substantially into the light path;
in the first state, projecting a hard edge light onto a projection surface from the theatre lighting apparatus; and
in the second state projecting a soft edge light onto the projection surface from the theatre lighting apparatus.

28. The method of claim 26
wherein the optical power varying system is comprised of two flags of patterned glass.

29. The method of claim 27
wherein the optical power varying system is comprised of two flags of patterned glass.

30. A method comprising:
generating a light having a light path from a central lamp of a theatre lighting apparatus;
remotely positioning a lamp housing of the theatre lighting apparatus in relation to a base of the theatre lighting apparatus by a motor;
causing the central lamp, a reflector, a color varying system, and a lens of the theatre lighting apparatus to cooperate to project a first variable colored light from an output aperture of the theatre lighting apparatus;
wherein the color varying system is comprised of a plurality of color flags, including a first magenta flag, a second magenta flag, a first cyan flag, and a second cyan flag;
further comprising varying the first magenta flag into the light path by a first motor;
varying the second magenta flag into the light path by a second motor;
varying the first cyan flag into the light path by a third motor;
varying the second cyan flag into the light path by a fourth motor;
wherein the first magenta flag is varied into the light path in response to a first command received by a communications port of the theatre lighting apparatus;
and wherein the second magenta flag is not varied into the light path in response to the first command.

31. The method of claim 30 further comprising
receiving a second command at the communications port; and
varying the first cyan flag into the light path in response to the second command;
and wherein the second cyan flag is not varied into the light path in response to the second command.

32. The method of claim 31 wherein
the first and second commands are compliant with the DMX protocol.

33. A method comprising:
remotely positioning a lamp housing of a theatre lighting apparatus in relation to a base of a theatre lighting apparatus by a motor;
causing a central lamp, a reflector, a color varying system, and a polymer lens of the theatre lighting apparatus to cooperate to project a first variable colored light from the theatre lighting apparatus; and
locating a plurality of air vents in proximity to the polymer lens.

34. The method of claim 33 wherein
the polymer lens is a fresnel lens.

35. The method of claim 34 wherein
the air vents are intake air vents.

36. A method comprising:
remotely positioning a lamp housing of a theatre lighting apparatus in relation to a base of a theatre lighting apparatus by a motor;
causing a central lamp, a reflector, a color varying system, and a polymer lens of the theatre lighting apparatus to cooperate to project a first variable colored light from an output aperture of the theatre lighting apparatus; and
locating an air vent in proximity to the polymer lens and a plurality of light emitting diodes.

37. The method of claim 36 wherein
the polymer lens is a fresnel lens.

38. The method of claim 37 wherein
the air vent is an intake air vent.
